(19) United States
(12) Patent Application Publication
(10) Pub. No.: US 2006/0047083 A1
(43) Pub. Date: Mar. 2, 2006

(54) Triblock copolymers and their production methods

(76) Inventors: Iskender Yilgor, Istanbul (TR); Emel Yilgor, Istanbul (TR); Thomas C. Ward, Blacksburg, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/202,372

(22) Filed: Aug. 12, 2005

Related U.S. Application Data
(60) Provisional application No. 60/605,162, filed on Aug. 30, 2004.

(51) Int. Cl. C08F 297/00

(52) U.S. Cl. 525/314; 528/44

(57) ABSTRACT

A new family of triblock (A-B-A type) thermoplastic, polyurethane, polyurethaneurea, polyurea and polyamide copolymers has been prepared. (A) blocks represent the hard segments, such as urethane, urea, urethaneurea or amide type segments. (B) blocks represent the soft segments, such as aliphatic polyethers, aliphatic polyesters, polydimethylsiloxanes, polyalkanes or their copolymers. These novel material display very interesting microphase morphologies, mechanical properties, solubility characteristics and melt behavior.

### RELATED APPLICATION

This application claims benefit of U.S. Provisional Application No. 60/605,162 filed Aug. 30, 2004, titled “ABA Triblock copolymers with terminal (A) hard segment blocks capable of forming strong hydrogen bonding.”

### FIELD OF THE INVENTION

This invention relates to triblock copolymers, methods of producing triblock copolymers, and properties of triblock copolymers.

### BACKGROUND OF THE INVENTION

Chemistry, technology, structure-property relations, performance characteristics and applications of segmented thermoplastic polyurethanes, polyurethaneureas, polyureas (TPU) and polyamides have been well established. Referring to the following formula (I),
(-A-B—)ₙ (I)
these types of materials consist of high molecular weight (i.e., in a range of about 20 to 200 kDaltons), linear macromolecules that are based on alternating hard (A) and soft (B) segments along the polymer backbone. The number “n” usually is in a range of about 10 to 100. Hard segments can be urethane, urea, urethaneurea or amide type structures. Soft segments include but are not limited to aliphatic polyethers, aliphatic polyesters, silicones, polyalkanes, polyalkenes or their copolymers. Morphology, physical and chemical properties, performance and applications of these materials strongly depend on the chemical composition of the backbone; type, nature, average molecular weight and amount of hard and soft segments; overall molecular weight of the copolymer; processing conditions; and thermal history.

Examples of triblock copolymers disclosed in the patent literature are as follows.

U.S. Pat. Nos. 4,954,579 and 5,008,347 (issued to The Dow Chemical Company) both titled “Polyalkyloxazoline-polycarbonate-polyalkyloxazoline triblock copolymer compatibilizer for polycarbonate/polyamide blends” disclose polyalkyloxazoline-polycarbonate-polyalkyloxazoline triblock copolymers.

U.S. Pat. Nos. 5,112,900 and 5,407,715 (issued to Tactyl Technologies, Inc.) both titled “Elastomeric triblock copolymer compositions and articles made therefrom” disclose styrene-ethylene/butylenes-styrene (S-EB-S) elastomeric triblock copolymers used in making an elastomeric composition.

U.S. Pat. No. 5,458,792 (issued to Shell Oil Company) titled “Asymmetric triblock copolymer viscosity index improves for oil compositions” discloses triblock copolymers that have the block structure hydrogenated polyisoprene-polystyrene-hydrogenated polyisoprene wherein the ratio of the number average molecular weights of the first and second hydrogenated polyisoprene blocks is at least 4 (abstract).

U.S. Pat. No. 5,709,852 (issued to BASF Corporation) titled “Ethylene oxide/propylene oxide/ethylene oxide (EO/PO/EO) triblock copolymer carrier blends” discloses an a non-ionic liquid triblock EO/PO/EO copolymer of molecular weight 1,000 to 5,000 and a non-ionic solid triblock EO/PO/EO copolymer of molecular weight 4,000 to 16,000 (abstract).

U.S. Pat. No. 6,166,134 (issued to Shell Oil Company) titled “Polypropylene resin composition with tapered triblock copolymer” discloses a triblock copolymer having the structure A-B-(A/B) wherein A is a vinyl aromatic hydrocarbon homopolymer, B is an isoprene homopolymer, and (A/B) is a block of a tapered isoprene-vinyl aromatic hydrocarbon copolymer (abstract).

In U.S. Pat. No. 6,616,946 (issued to BioCure, Inc.) titled “Triblock copolymer hollow particles for agent delivery by permeability change,” “A” is a hydrophilic block and “B” is a hydrophobic block.

To the best of the inventors' knowledge, conventional thermoplastic polyurethane, polyurethaneurea and polyurea technology thus far has been limited to segmented copolymers, which consist of macromolecules composed of alternating hard and soft segments along a linear chain. In these segmented systems, soft segment molecular weights are usually within a fairly small range of 500 to 5,000 g/mole, although they can be higher. Conventional thermoplastic polyurethanes have been segmented architectures.

### SUMMARY OF THE INVENTION

The present invention provides novel polymer design, novel synthetic processes, and novel compositions of matter comprising A-B-A type triblock copolymers wherein the hard segments “A” are either oligomeric or polymeric ureas, urethanes, urethaneureas or amides (such as, e.g., polyurea, polyurethane, polyurethaneurea, polyamide). Novel A-B-A type triblock copolymers advantageously provide strong hydrogen bonding capability. The A-B-A type triblock copolymers of the invention are thermoplastic, such as TPUs and thermoplastic polyamides. “A” means a hard segment; “B” means a soft segment.

Inventive methods for making A-B-A type triblock copolymers with strongly hydrogen bonding A blocks are provided, such as, e.g., a one pot synthesis method comprising: first creating an isocyanate terminated prepolymer by the addition of excess diisocyanate to the soft segment polymer, followed by addition of a chain extender and end-capper to the pot. Because of the presence of the excess diisocyanate in the pot, a polyurethane, polyurea, or polyurethaneurea is created by the reaction of the diisocyanate with the selected diol, diamine or alcoholamine chain extender respectively. Molecular weights of the hard blocks are controlled by the use of monofunctional alcohols or amines as the end-capper. This leaves a triblock copolymer with either polyurea, polyurethane, or polyurethaneurea at each end, where the copolymer is capped using the end-capper added to the pot together with the chain extender. Depending on the ratio of chain extender to end-capper, the length of the polyurethane, polyurea, and polyurethaneurea hard segments can be regulated.

In one preferred embodiment, the invention provides a method of making a triblock copolymer having the general structure A-B-A where A is a hard segment selected from the group consisting of polymeric or oligomeric ureas, urethanes, urethaneureas or amides and B is a polymeric or oligomeric soft segment, comprising the steps of: forming an isocyanate terminated polymeric or oligomeric soft segment by reacting excess diisocyanate (such as, e.g., 2,4-tolylene diisocyanate; 2,6-tolylene diisocyanate; 4,4′-phenlyene diisocyanate; p-phenylene diisocyanate; m-phenylene diisocyanate; hexamethylene diisocyanate, bis(4-isocyanatocyclohexyl)methane; 1,4-cyclohexyl diisocyanate; isophorone diisocyanate; diisocyanate having the general structure OCN—R_{DI}—NCO, where R_{DI} is an alkyl, aryl, or aralkyl moiety having 4-20 carbon atoms) with said soft segment; combining said isocyanate terminated polymeric or oligomeric soft segment and said excess diisocyanate with one or more chain extenders (such as, e.g., diols, diamines, alcoholamines, dicarboxylic acids, etc.) to form an A-B-A triblock copolymer. Preferably the combining step includes a monofunctional amine or alcohol end-blocker in the combination.

Examples of the polymeric or oligomeric soft segment are, e.g., aliphatic polyethers, aliphatic polyesters, silicones, polyalkanes, and combinations thereof; polymeric or oligomeric soft segments having a general structure selected from the group consisting of
HO—((CH₂)ₓ—O—)_{y}—H (II-a)
HO—(—C(CH₃)H—CH₂—O—)_{y}—CH₂—C(CH₃)H—OH (II-b)
HO—R₂₀—((CH₂)ₓ—O—)_{y}—R₂₀—OH (II-c)
H₂N—R₂₁—((CH₂)ₓ—O—)_{y}—R₂₁—NH₂ (II-d)
HR₂₃N—R₂₂—((CH₂)ₓ—O—)_{y}—R₂₂—NHR₂₃ (II-e)
where R₂₀, R₂₁, R₂₂ and R₂₃ indicate a linear or branched alkyl radical with 1 to 10 carbon atoms; x is an integer between 2 and 6; y is a number between 20 and 200 (wherein hydroxy and amine end groups can be primary or secondary); polymeric or oligomeric soft segments having the general structure
HO—R₄—(O—C(O)—R₅—C(O)—O—R₄)ₓ₃OH (III)
where R₄ and R₅ represent linear or branched alkyl radicals with 2 to 20 carbon atoms, and the degree of polymerization, x3, is between 10 and 300 inclusive (i.e. including 10 and 300); polymeric or oligomeric soft segments having the general structure
HO—(CH₂)ₓ₄—(—C(O)—(CH₂)ₓ₄O—)_{y4}H (IV)
where x4 is between 2 and 7 inclusive, and y4 is between 10 and 500 inclusive; polymeric or oligomeric soft segments having the general structure
HO—((R₁₅)ₙ—(R₂₅)ₘ)ₓ₅—OH (V-a) or
H₂N—((R₁₅)ₙ—(R₂₅)ₘ)ₓ₅—NH₂ (V-b)
where R₁₅ and R₂₅ are linear alkyl radicals (such as (—CH₂—)_{yy}) or branched radicals with 1 to 15 carbon atoms; n is between 1 and 100; m is between 1 and 100; and x5 is between 10 and 5000; polymeric or oligomeric soft segments having the general structure
HO—((CH₂)ₓ₆—C(O)O—)_{y6}(R₆—O—)_{z6}—((CH₂)ₓ₆—C(O)—)_{y6}O—H (VI)
wherein R₆ means (CH₂)₄, (CH₂)₅ or (CH₂)₆; x6 is between 2 and 6; y6 is between 20 and 200; z6 is between 1 and 1000; polymeric or oligomeric soft segments having the general structure selected from the group consisting of (VII-a) and (VII-b): 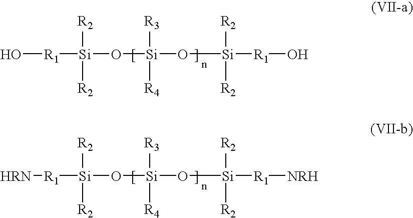
wherein R is a hydrogen atom or a linear or branched alkyl chain with 1 to 6 carbon atoms; R₁ is a linear or branched alkyl chain with 1 to 12 C atoms; R₂ is a methyl group; R₃ is a methyl, ethyl or phenyl group; R₄ is a methyl, ethyl, phenyl, hydrogen, 3,3,3-trifluoropropyl group; and n is between 10 and 500 inclusive.

### BRIEF SUMMARY OF THE DRAWINGS

FIG. 1 shows an inventive reaction scheme for producing an inventive A-B-A triblock copolymer 33 in two steps. The A-B-A triblock copolymer 33 comprises terminal hard segments 33A and a soft segment 33B.

FIG. 2 is a graph of stress-strain curves for certain exemplary A-B-A triblock polyurea-polyether-polyurea copolymers according to the invention. FIG. 2 shows data typical for inventive Examples 1-6.

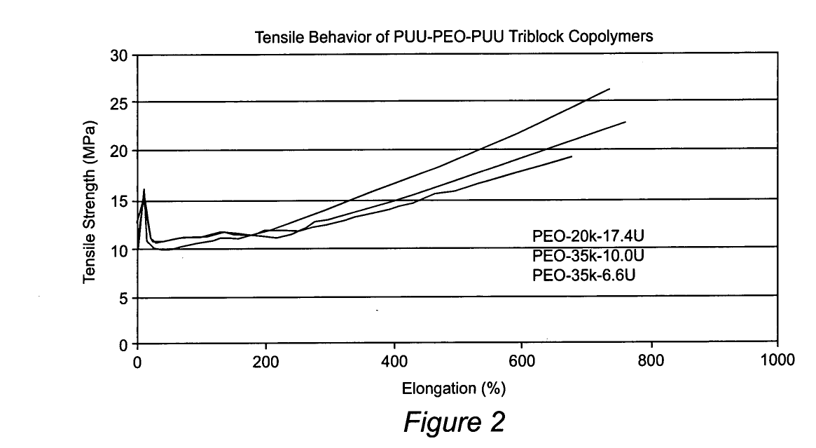

### DETAILED DESCRIPTION OF A PREFERRED EMBODIMENT OF THE INVENTION

Examples of hard segments (A) in inventive A-B-A triblock copolymers are, e.g., urethane, urea, urethaneurea and amide obtained by the reaction of diisocyanates with diols, diamines, alcoholamines, or dicarboxylic acids respectively.

Examples of soft segments (B) in inventive A-B-A triblock copolymers include but are not limited to, e.g., aliphatic polyethers, aliphatic polyesters, silicones, polyalkanes or their copolymers, etc.

Examples of soft segments include but are not limited to:

α,ω-Dihydroxy or α,ω-diamino terminated aliphatic polyethers, such as poly(tetramethylene oxide), poly(ethylene oxide), poly(propylene oxide), and/or their copolymers, represented by the general formulae (II-a through II-e) below:
HO—((CH₂)ₓ—O—)_{y}—H (II-a)
HO—(—C(CH₃)H—CH₂—O—)_{y}—CH₂—C(CH₃)H—OH (II-b)
HO—R₂₀—((CH₂)ₓ—O—)_{y}—R₂₀—OH (II-c)
H₂N—R₂₁—((CH₂)ₓ—O—)_{y}—R₂₁—NH₂ (II-d)
HR₂₃N—R₂₂—((CH₂)ₓ—O—)_{y}—R₂₂—NHR₂₃ (II-e)
where R₂₀, R₂₁, R₂₂ and R₂₃ indicate a linear or branched alkyl radical with 1 to 10 carbon atoms; x is an integer between 2 and 6; y is a number between 20 and 200 (wherein hydroxy and amine end groups can be primary or secondary);

aliphatic polyester glycols represented by the following general formula (III):
HO—R₄—(O—C(O)—R₅—C(O)—O—R₄)ₓ₃OH (III)
obtained by condensation reactions of diols and dicarboxylic acids (such as poly(butylenes adipate), poly(neopentyl adipate), poly(butylene hexanoate, etc.), where R₄ and R₅ represent linear or branched alkyl radicals with 2 to 20 carbon atoms, and the degree of polymerization, x3, is between 10 and 300 inclusive (i.e. including 10 and 300);

aliphatic polyester glycols represented by the following general formula (IV):
HO—(CH₂)ₓ₄—(—C(O)—(CH₂)ₓ₄O—)_{y4}H (IV)
obtained by ring opening polymerization reactions (such as polycaprolactone, etc.), where x4 is between 2 and 7 inclusive, and y4 is between 10 and 500 inclusive;

α,ω-Dihydroxy or α,ω-diamino terminated polyalkanes, such as polyisobutylene or those obtained by the hydrogenation of polybutadiene or polyisoprene, represented by either of the following general formulae (V-a) and (V-b):
HO—((R₁₅)ₙ—(R₂₅)ₘ)ₓ₅—OH (V-a)
H₂N—((R₁₅)ₙ—(R₂₅)ₘ)ₓ₅—NH₂ (V-b)
where R₁₅ and R₂₅ are linear alkyl radicals (such as (—CH₂—)_{yy}) or branched radicals [such as (—CHRᵥ—)_{yy} where Rᵥ is a methyl, ethyl, propyl, butyl, pentyl, hexyl, heptyl, octyl, isopropyl, isobutyl, neopentyl, etc. radical] with 1 to 15 carbon atoms; n is between 1 and 100; m is between 1 and 100; and x5 is between 10 and 5000;

copolymeric glycols obtained by the ring opening polymerization of cyclic ester monomers using polyether oligomers, represented by the following general formula (VI):
HO—((CH₂)ₓ₆—C(O)O—)_{y6}(R₆—O—)_{z6}—((CH₂)ₓ₆—C(O)—)_{y6}O—H (VI)
wherein R₆ means (CH₂)₄, (CH₂)₅ or (CH₂)₆; x6 is between 2 and 6; y6 is between 20 and 200; z6 is between 1 and 1000;

α,ω-Dihydroxyalkyl (VII-a) or α,ω-diaminoalkyl (VII-b) terminated polydimethylsiloxane (PDMS), polydimethyl,trifluoropropylmethylsiloxane or other silicone oligomers represented by formulae (VII-a) and (VII-b): 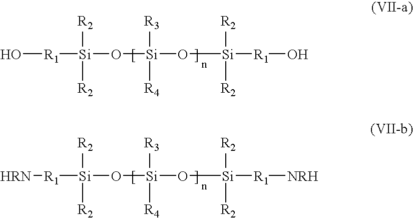
wherein R is a hydrogen atom or a linear or branched alkyl chain with 1 to 6 carbon atoms; R₁ is a linear or branched alkyl chain with 1 to 12 carbon atoms; R₂ is a methyl group; R₃ is a methyl, ethyl or phenyl group; and R₄ is a methyl, ethyl, phenyl, hydrogen, 3,3,3-trifluoropropyl group; and n is between 10 and 500 inclusive.

The “A” hard segments of the A-B-A triblock polymer of the present invention are oligomeric or polymeric in character and are preferably polyureas, polyurethanes, polyurethaneureas or polyamides made by reacting diisocyanates with chain extenders. First, the “B” soft segment is reacted with a calculated excess of the diisocyanate to obtain isocyanate terminated soft middle blocks. Then, the excess diisocyanate is reacted with chain extenders to produce polymeric or oligomeric urea, urethane or urethaneurea hard segments covalently bonded to the “B” soft segment. The “size” or “length” of the “A” hard segments is controlled by regulating the amount of diisocyanate, and chain extender to end capper during the reaction, as well as the reaction conditions.

With regard to diisocyanates useable as preparation materials, both aromatic and aliphatic diisocyanates may be used for the preparation of triblock polyurethanes in this invention. Examples of aromatic diisocyanates include but are not limited to, e.g., 2,4-tolylene diisocyanate, 2,6-tolylene diisocyanate or their mixtures (TDI), 4,4′-phenylene diisocyanate (MDI), p-phenylene diisocyanate (PPDI), m-phenylene diisocyanate (MPDI), 1,3-Bis(isocyanatoisopropyl)benzene, etc. Examples of aliphatic diisocyanates include, but are not limited to, e.g., hexamethylene diisocyanate (HDI), bis(4-isocyanatocyclohexyl)methane (HMDI), isophorone diisocyanate (IPDI), etc. A diisocyanate within the practice of this invention may have the general structure OCN—R_{DI}—NCO, where R_{DI} is an alkyl, aryl, or aralkyl moiety having 4 to 20 carbon atoms.

In producing novel triblock copolymers according to the invention, chain extenders may be used, such as diols, diamines, alcoholamines, and dicarboxylics. Preferred diol chain extenders are aliphatic diols with the following general formula (X-V),
HO—(CH₂)ₓₓ—OH (X-V)
where xx is between 2 and 20 inclusive. Preferred diamine chain extenders are aliphatic diamines with the following general formula (X-VI),
H₂N—(CH₂)ₓₓ—NH₂ (X-VI)
where xx is between 2 and 20 inclusive. Preferred alcoholamine chain extenders are aliphatic hydroxyamines with the following general formula (X—VII),
HO—(RX)—NH₂ (X-VII)
where RX is an alkyl chain with a structure of (CH₂)ₓₓ wherein xx is between 2 and 20 inclusive or is an ether chain with a general structure of (—(CH₂)ₓₚ—O—(CH₂)ₓₚ—)ₙₚ where (xp) is between 1 and 6 inclusive and (np) is between 1 and 10 inclusive. Preferred dicarboxylic acid chain extenders are aliphatic dicarboxylic acids with the following general formula (X-VII),
HOOC—(CH₂)ₓₓ—COOH (X-VIII)
where (xx) is between 2 and 20 inclusive.

Examples of a urea hard segment are, e.g., polyurea polymers or oligomers (such as, e.g., a urea hard segment that includes a polyurea polymer or oligomer formed from a diisocyanate having the general structure OCN—R_{DI}—NCO, where R_{DI} is an alkyl, aryl, or aralkyl moiety having 4 to 20 carbon atoms, and a diamine having the general structure HR_{A}N—R_{AM}—NR_{A}H, where R_{A} is a hydrogen or alkyl group having 1-6 carbon atoms, and R_{AM} is an alkyl, aryl, or alkaryl group having 2 to 20 carbon atoms); polyurethane polymers or oligomers (such as, e.g., a urethane hard segment that includes a polyurethane polymer or oligomer formed from a diisocyanate having the general structure OCN—R_{DI}—NCO, where R_{DI} is an alkyl, aryl, or aralkyl moiety having 4 to 20 carbon atoms, and a diol having the general structure HO—R_{AL}—OH, R_{AL} is an alkyl, aryl, or alkaryl group having 2 to 20 carbon atoms); and combinations thereof. The polyurea or oligomeric urea hard segments according to this invention have the general structure shown below: 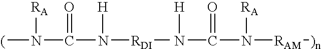
The polyurethane or oligomeric urethane hard segments according to this invention have the general structure shown below: 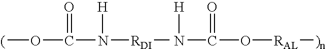
The polyurethaneureas according to this invention have the general structure shown below: 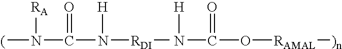
where R_{A} is a hydrogen or alkyl group having 1-6 carbon atoms; R_{DI} is an alkyl, aryl, or aralkyl moiety having 4 to 20 carbon atoms; R_{AM} is an alkyl, aryl, or alkaryl group having 2 to 20 carbon atoms; R_{AL} is an alkyl, aryl, or alkaryl group having 2 to 20 carbon atoms.

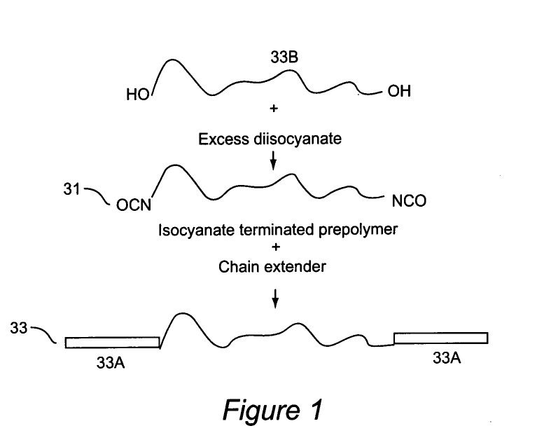

A-B-A type triblock polyurethanes, polyureas, polyurethaneureas and polyamides may be synthesized in one pot, in two steps, as shown schematically in FIG. 1. In the reactions of FIG. 1, an alcohol (such as ethanol, 1-butanol, 1-hexanol, etc.) or an amine (such as 1-butylamine, dibutylamine, etc.) may be used to cap the isocyanate end-groups of the final product.

In the first step, a starting material comprises soft segment 33B terminated with glycol, diamine or dicarboxylic acid. The glycol, diamine or dicarboxylic acid terminated soft segment oligomer (or polymer) is reacted with excess diisocyanate to obtain a prepolymer mixture.

In the second step, a stoichiometric amount of chain extender (e.g., diols, diamines, alcoholamines, or dicarboxylic acids) plus an end-blocker (alcohol or amine) mixture is added into the system and reacted to obtain the triblock copolymer. To form A-B-A triblock copolymers with reactive end groups (such as hydroxyl or amine terminated polymers), a slight excess of chain extender may be used. To form non-reactive end groups, isocyanate end groups of the triblock copolymers can be capped with monofunctional alcohols or amines. The block length of the soft segments are determined by the molecular weight of the oligomeric glycol (or oligomeric diamine) used. Average molecular weight of the hard segments is determined by the initial stoichiometry of the reaction.

Examples of chain extenders are, e.g., chain extenders with the general structure selected from the group consisting of: HO—(R_{CE15})—OH; HRN—(R_{CE25})—NHR_{CE} and HRN—(R_{CE35})—OH, where R_{CE} is a hydrogen or a linear or branched alkyl radical with 1 to 4 carbon atoms; R_{CE15} is a linear or branched alkyl radical with 1 to 15 carbon atoms or an ether group with 1 to 20 carbon atoms; R_{CE25} is a linear or branched alkyl radical with 1 to 15 carbon atoms or an ether group with 1 to 20 carbon atoms; R_{CE35} is a linear or branched alkyl radical with 1 to 15 carbon atoms or an ether group with 1 to 20 carbon atoms; chain extenders having the general structure
HOOC—(CH₂)ₓ—COOH (X-VIII)
where (xx) is between 2 and 20 inclusive; etc.

When the chain extender is used in the combining step, the combining step may include adding an amine or alcohol end-capper together with said chain extender. Examples of the end-capper are, e.g., a structure selected from the group consisting of HO—R_{1E} and HR_{2E}N—R_{3E} wherein R_{1E} is a linear or branched alkyl, aryl or aralkyl chain with 1 to 20 carbon atoms or an ether group with 4 to 20 carbon atoms; R_{2E} is a hydrogen atom or a linear or branched alkyl chain with 1 to 4 carbon atoms; and R_{3E} is a linear or branched alkyl, aryl or aralkyl chain with 1 to 20 carbon atoms or an ether group with 4 to 20 carbon atoms.

To obtain inventive A-B-A type TPUs or thermoplastic polyamides with good mechanical properties and tensile strength can be obtained by optimizing the important reaction variables, such as the average molecular weight of the soft segment (which preferably is higher than the critical entanglement molecular weight) and the nature, type and average molecular weight of the hard segments. Strong hydrogen bonding between hard segments leads to a microphase separated morphology and formation of thermoplastic elastomers with excellent physical properties.

The invention may be better appreciated with regard to the Examples given below, but the invention is not limited to the Examples.

### EXAMPLE 1

### Preparation of Polyurea-Poly(ethylene oxide)-Polyurea triblock copolymer

10.00 g (0.50 mmol) of poly(ethylene oxide)glycol with number average molecular weight (Mₙ) of 20,000 g/mol (PEO-20k) was introduced into a 250 mL, three-neck, round bottom flask fitted with an overhead stirrer, nitrogen inlet and addition funnel. 1.58 g (6.02 mmol) of bis(4-isocyanatocyclohexyl)methane (HMDI) was also introduced into the reactor and mixture was heated to 80° C., which formed a clear, homogeneous melt. One drop of a 1% dibutyltin dilaurate (T-12) solution in toluene was added as catalyst. After 1 hour of reaction, FTIR spectroscopy showed the completion of prepolymer reaction. Prepolymer was dissolved in 16.50 g of dimethylformamide (DMF) and the solution was cooled down to room temperature. 0.58 g (4.99 mmol) 2-methyl-1,5-diaminopentane (DYTEK) and 0.0700 g (0.96 meq) n-butylamine (BuA) were weighed into an Erlenmeyer flask, dissolved in 15.00 g of isopropanol (IPA) and introduced into the addition funnel. DYTEK+BuA solution was added into the reactor dropwise at room temperature. After 50% addition solution became viscous and diluted with 27.00 g DMF. After 75% addition, 11.60 g IPA was added for dilution. After complete addition of the amine mixture the reaction solution was diluted with 19.00 g of DMF. A film was cast on a Teflon mold; solvent was first evaporated at room temperature overnight, then in a 60° C. oven and finally in a vacuum oven at 60° C. until constant weight was reached.

### EXAMPLE 2

### Preparation of a Polyurea-Polyalkane-Polyurea triblock copolymer

13.58 g (4.07 mmol) of hydroxyl terminated liquid Kraton oligomer, which has a backbone composed of ethylene-propylene random copolymer and Mₙ value of 3,340 g/mol and 4.25 g HMDI (16.20 mmol) were weighed into a three-neck, 250 mL round bottom flask fitted with an overhead stirrer, nitrogen inlet and addition funnel. Mixture was heated to 80° C., which formed a clear, homogeneous melt. One drop of a 1% dibutyltin dilaurate (T-12) solution in toluene was added as catalyst. After 1 hour of reaction, FTIR spectroscopy showed the completion of prepolymer reaction. Prepolymer was dissolved in 27.80 g of tetrahydrofuran (THF) and the solution was cooled down to room temperature. 1.16 g (9.98 mmol) DYTEK and 0.31 g (4.25 meq) n-butylamine (BuA) were weighed into an Erlenmeyer flask, dissolved in 17.40 g of isopropanol (IPA) and introduced into the addition funnel. DYTEK+BuA solution was added into the reactor dropwise at room temperature. After 50% addition solution became viscous and diluted with 17.90 g THF. After complete addition of the amine mixture the reaction solution was diluted with 7.30 g of IPA. A film was cast on a Teflon mold; solvent was first evaporated at room temperature overnight, then in a 60° C. oven and finally in a vacuum oven at 60° C. until constant weight was reached.

### EXAMPLE 3

### Preparation of a Polyurea-Polydimethylsiloxane-Polyurea triblock copolymer

1.05 g (4.00 mmol) of HMDI was introduced into a 250 mL, three-neck, round bottom flask fitted with an overhead stirrer, nitrogen inlet and addition funnel and dissolved in 18.50 g IPA. 10.89 g of α-ω-aminopropyl terminated polydimethylsiloxane oligomer (PDMS) with Mₙ=11,800 g/mol was weighed into an Erlenmeyer flask, dissolved in 27.30 g IPA and introduced into the addition funnel. PDMS solution was added into the reactor dropwise at room temperature. 0.23 g DYTEK (1.98 mmol) was dissolved in 18.40 g of IPA and added into the reactor. 0.15 g (2.05 meq) of BuA was dissolved in 12.00 g IPA and added into the reaction mixture dropwise to cap the isocyanate end groups. Completion of reactions at each step was monitored by FTIR spectroscopy. A film was cast on a Teflon mold; solvent was first evaporated at room temperature overnight, then in a 60° C. oven and finally in a vacuum oven at 60° C. until constant weight was reached.

### EXAMPLE 4

### Preparation of a Polyurea-Poly(propylene oxide)-Polyurea triblock copolymer

13.66 g (1.16 mmol) of poly(propylene oxide)glycol with number average molecular weight (Mₙ) of 11,810 g/mol (PPO-12k) was introduced into a 250 mL, three-neck, round bottom flask fitted with an overhead stirrer, nitrogen inlet and addition funnel. 2.44 g (9.30 mmol) HMDI was also introduced into the reactor and mixture was heated to 80° C., which formed a clear, homogeneous solution. One drop of a 1% dibutyltin dilaurate (T-12) solution in toluene was added as catalyst. After 1 hour of reaction, FTIR spectroscopy showed the completion of prepolymer reaction. Prepolymer was dissolved in 26.90 g of DMF and the solution was cooled down to room temperature. 0.81 g (6.97 mmol) DYTEK and 0.17 g (1.16 meq) BuA were weighed into an Erlenmeyer flask, dissolved in 33.60 g of DMF and introduced into the addition funnel. DYTEK+BuA solution was added into the reactor dropwise at room temperature. After 50% addition the solution was diluted with 7.00 g of IPA. After complete addition of the amine mixture the reaction solution was diluted with 4.30 g of IPA. A film was cast on a Teflon mold; solvent was first evaporated at room temperature overnight, then in a 60° C. oven and finally in a vacuum oven at 60° C. until constant weight was reached.

### EXAMPLE 5

### Preparation of Polyurethane-Poly(ethylene oxide)-Polyurethane triblock copolymer

17.50 g (0.50 mmol) of poly(ethylene oxide)glycol with number average molecular weight (Mₙ) of 35,000 g/mol (PEO-35k) was introduced into a 250 mL, three-neck, round bottom flask fitted with an overhead stirrer, nitrogen inlet and addition funnel. 1.75 g of bis(4-isocyanatophenyl)methane (MDI) (7.00 mmol) was also introduced into the reactor. The mixture was dissolved in 30.00 g of DMF and heated to 60° C., which formed a clear, homogeneous solution. After 4 hours of reaction, FTIR spectroscopy showed the completion of prepolymer reaction. Prepolymer solution was cooled down to room temperature. 0.54 g (6.00 mmol) of 1,4-butanediol (BD) and 0.074 g (1.00 mmol) n-butanol (BuOH) were weighed into an Erlenmeyer flask, dissolved in 15.00 g of DMF and added into the reaction mixture. During polymerization as the reaction mixture became viscous, it was diluted with DMF. Completion of the reaction was determined by FTIR spectroscopy, monitoring the disappearance of the strong isocyanate absorption peak at 2270 cm⁻¹. A film was cast on a Teflon mold; solvent was first evaporated at room temperature overnight, then in a 60° C. oven and finally in a vacuum oven at 60° C. until constant weight was reached.

### EXAMPLE 6

### Preparation of Polyurethaneurea-Polycaprolactone-Polyurethaneurea triblock copolymer

15.00 g (0.50 mmol) of hydroxyl-terminated polycaprolactone oligomer with number average molecular weight (Mₙ) of 30,000 g/mol (PCL-30k) was introduced into a 250 mL, three-neck, round bottom flask fitted with an overhead stirrer, nitrogen inlet and addition funnel. 1.05 g (4.00 mmol) of bis(4-isocyanatocyclohexyl)methane (HMDI) was also introduced into the reactor and mixture was heated to 80° C., which formed a clear, homogeneous melt. One drop of a 1% dibutyltin dilaurate (T-12) solution in toluene was added as catalyst. After 2 hours of reaction, FTIR spectroscopy showed the completion of prepolymer reaction. Prepolymer was dissolved in 20.00 g of dimethylformamide (DMF) and the solution was cooled down to room temperature. 0.3486 g (3.00 mmol) 2-methyl-1,5-diaminopentane (DYTEK) and 0.0734 g (1.00 meq) n-butylamine (BuA) were weighed into an Erlenmeyer flask, dissolved in 15.00 g of isopropanol (IPA) and introduced into the addition funnel. DYTEK+BUA solution was added into the reactor dropwise at room temperature. After 50% addition solution became viscous and diluted with 27.00 g DMF. After 75% addition, 12.00 g IPA was added for dilution. After complete addition of the amine mixture the reaction solution was diluted with 15.00 g of DMF. A film was cast on a Teflon mold; solvent was first evaporated at room temperature overnight, then in a 60° C. oven and finally in a vacuum oven at 60° C. until constant weight was reached.

The polymers of Examples 1-6 were characterized as follows. FTIR spectra were recorded on a Nicolet NEXUS 670 model spectrophotometer with a resolution of 2 cm⁻¹. GPC measurements were performed on a Waters system equipped with Styragel® HT columns and an R1 detector. Measurements were conducted in N-methylpyrrolidone containing 0.05 M LiBr with a flow rate of 1 mL per min. During GPC measurements column and detector temperatures were maintained at 60 and 30° C. respectively. Average molecular weights were determined using polystyrene standard calibration. Stress-strain tests were performed on an Instron Model 4411 Universal Tester, at room temperature, with a crosshead speed of 25 mm/min. For stress-strain tests, dog-bone type microtensile test specimens were punched out of thin copolymer films (0.3 to 0.7 mm in thickness) using a standard die (ASTM D 1708). Stress-strain tests were performed on 5 specimens for each copolymer sample and average values are reported.

TABLE 1
Compositions of A-B-A type triblock Polyurethaneurea-Poly
(ethylene oxide)-Polyurethaneurea (PUU-PEO-PUU) Copolymers

| Sample | Diisocyanate | Chain Extender | HS (wt %) |
|---|---|---|---|
| PEO-20k-17.4U | HMDI | Dytek A | 17.4 |
| PEO-35k-10.0U | HMDI | Dytek A | 10.0 |
| PEO-35k-6.6U | HMDI | TEGDA | 6.6 |

TABLE 2
Tensile properties of triblock PUU-PEO-PUU Copolymers

| | | | Elong. |
|---|---|---|---|
| Sample | Modulus (MPa) | Tensile Strength (MPa) | (%) |
| PEO-20k-17.4U | 310 | 24.6 | 680 |
| PEO-35k-10.0U | 320 | 21.3 | 730 |
| PEO-35k-6.6U | 230 | 18.6 | 660 |

TABLE 3
Compositions of A-B-A type triblock Polyurethaneurea Copolymers
with different soft (B) segments

| Sample | Diisocyanate | Chain Extender | HS (wt %) |
|---|---|---|---|
| PPO-12k-20.0U | HMDI | Dytek A | 20.0 |
| Karton-3.3k-29.6U | HMDI | Dytek A | 29.6 |

TABLE 4
Tensile properties of triblock PUU-PEO-PUU Copolymers

| | | | Elong. |
|---|---|---|---|
| Sample | Modulus (MPa) | Tensile Strength (MPa) | (%) |
| PPO-12k-20.0U | 2.38 | 2.50 | 250 |
| Karton-3.3k-29.6U | 9.75 | 8.00 | 150 |

Tensile test results provided on Table 2 clearly demonstrate the formation of very strong thermoplastic elastomers with excellent mechanical properties. This architecture of the A-B-A type triblock with the strongly hydrogen bonding terminal (A) blocks is novel. Advantageously, the novel A-B-A type triblock with the strongly hydrogen bonding terminal (A) blocks provide excellent mechanical strength at fairly low hard segment contents, such as a hard segment content in a range of about 5 to 20% by weight, much lower than typical segmented TPUs. Copolymers with polyamide hard blocks may also provide good thermal stability together with low melt viscosities for easier processing.

These novel A-B-A triblock copolymers may have applications as coatings, elastomers, biomaterials, additives, tougheners, processing aids, polymeric compatibilizers, binders for films and fibers derived from biomass materials, surface active agents, etc.

With inventive A-B-A type TPUs, high strength materials may be provided with a much lower hard segment content compared to conventional segmented TPUs. A-B-A type TPUs, which are novel, may also have lower overall molecular weights than conventional segmented TPUs and as a result provide lower melt viscosities.

While the invention has been described in terms of its preferred embodiments, those skilled in the art will recognize that the invention can be practiced with modification within the spirit and scope of the appended claims.

What we claim as our invention is:

1. A method of making a triblock copolymer having the general structure A-B-A where A is a hard segment selected from the group consisting of polymeric or oligomeric ureas, urethanes, urethaneureas or amides and B is a polymeric or oligomeric soft segment, comprising the steps of:
forming an isocyanate terminated polymeric or oligomeric soft segment by reacting excess diisocyanate with said soft segment;
combining said isocyanate terminated polymeric or oligomeric soft segment and said excess diisocyanate with one or more chain extenders to form an A-B-A triblock copolymer.

2. The method of claim 1, wherein the combining steps includes combining said isocyanate terminated polymeric or oligomeric soft segment and said excess diisocyanate with one or more chain extenders and with a monofunctional amine or alcohol end-blocker.

3. The method of claim 1 wherein said diisocyanate has the general structure OCN—R_{DI}—NCO, where R_{DI} is an alkyl, aryl, or aralkyl moiety having 4-20 carbon atoms.

4. The method of claim 3 wherein said diisocyanate is selected from the group consisting of 2,4-tolylene diisocyanate, 2,6-tolylene diisocyanate, 4,4′-phenlyene diisocyanate, p-phenylene diisocyanate, m-phenylene diisocyanate, hexamethylene diisocyanate, bis(4-isocyanatocyclohexyl)methane, 1,4-cyclohexyl diisocyanate and isophorone diisocyanate.

5. The method of claim 1 wherein at least one of said one or more chain extenders is selected from the group consisting of diols, diamines, alcoholamines, and dicarboxylic acids.

6. The method of claim 5 wherein at least one of said one or more chain extenders has the general structure selected from the group consisting of:
HO—(R_{CE15})—OH
HRN—(R_{CE25})—NHR_{CE}
HRN—(R_{CE35})—OH
where R_{CE} is a hydrogen or a linear or branched alkyl radical with 1 to 4 carbon atoms; R_{CE15} is a linear or branched alkyl radical with 1 to 15 carbon atoms or an ether group with 1 to 20 carbon atoms; R_{CE25} is a linear or branched alkyl radical with 1 to 15 carbon atoms or an ether group with 1 to 20 carbon atoms; R_{CE35} is a linear or branched alkyl radical with 1 to 15 carbon atoms or an ether group with 1 to 20 carbon atoms.

7. The method of claim 5 wherein said at least one of said one or more chain extenders has the general structure
HOOC—(CH₂)ₓₓ—COOH (X-VIII)
where (xx) is between 2 and 20 inclusive.

8. The method of claim 1 wherein said polymeric or oligomeric soft segment is selected from the group consisting of aliphatic polyethers, aliphatic polyesters, silicones, polyalkanes, and combinations thereof.

9. The method of claim 1 wherein said polymeric or oligomeric soft segment has a general structure selected from the group consisting of
HO—((CH₂)ₓ—O—)_{y}—H (II-a)
HO—(—C(CH₃)H—CH₂—O—)_{y}—CH₂—C(CH₃)H—OH (II-b)
HO—R₂₀—((CH₂)ₓ—O—)_{y}—R₂₀—OH (II-c)
H₂N—R₂₁—((CH₂)ₓ—O—)_{y}—R₂₁—NH₂ (II-d)
HR₂₃N—R₂₂—((CH₂)ₓ—O—)_{y}—R₂₂—NHR₂₃ (II-e)
where R₂₀, R₂₁, R₂₂ and R₂₃ indicate a linear or branched alkyl radical with 1 to 10 carbon atoms; x is an integer between 2 and 6; y is a number between 20 and 200 (wherein hydroxy and amine end groups can be primary or secondary).

10. The method of claim 1 wherein said polymeric or oligomeric soft segment has the general structure
HO—R₄—(O—C(O)—R₅—C(O)—O—R₄)ₓ₃OH (III)
where R₄ and R₅ represent linear or branched alkyl radicals with 2 to 20 carbon atoms, and the degree of polymerization, x3, is between 10 and 300 inclusive.

11. The method of claim 1 wherein said polymeric or oligomeric soft segment has the general structure
HO—(CH₂)ₓ₄—(—C(O)—(CH₂)ₓ₄O—)_{y4}H (IV)
where x4 is between 2 and 7 inclusive, and y4 is between 10 and 500 inclusive.

12. The method of claim 1 wherein said polymeric or oligomeric soft segment has the general structure
HO—((R₁₅)ₙ—(R₂)ₘ)ₓ₅—OH (V-a) or
H₂N—((R₁₅)ₙ—(R₂)ₘ)ₓ₅—NH₂ (V-b)
where R₁₅ and R₂₅ are linear alkyl radicals (such as (—CH₂—)_{yy}) or branched radicals with 1 to 15 carbon atoms; n is between 1 and 100; m is between 1 and 100; and x5 is between 10 and 5000.

13. The method of claim 1 wherein said polymeric or oligomeric soft segment has the general structure
HO—((CH₂)ₓ₆—C(O)O—)_{y6}(R₆—O—)_{z6}—((CH₂)ₓ₆—C(O)—)_{y6}O—H (V)
wherein R₆ means (CH₂)₄, (CH₂)₅ or (CH₂)₆; x6 is between 2 and 6; y6 is between 20 and 200; z6 is between 1 and 1000.

14. The method of claim 1 wherein said polymeric or oligomeric soft segment has the general structure selected from the group consisting of (VII-a) and (VII-b); 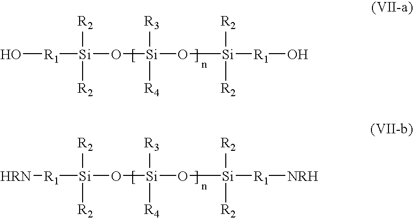
wherein R is a hydrogen atom or a linear or branched alkyl chain with 1 to 6 carbon atoms; R₁ is a linear or branched alkyl chain with 1 to 12 C atoms; R₂ is a methyl group; R₃ is a methyl, ethyl or phenyl group; R₄ is a methyl, ethyl, phenyl, hydrogen, 3,3,3-trifluoropropyl group; and n is between 10 and 500 inclusive.

15. The method of claim 1 wherein said combining step includes adding an amine or alcohol end-capper together with said chain extender, wherein the end-capper is of a structure selected from the group consisting of HO—R_{1E} and H_{R2E}N—R_{3E} wherein R_{1E} is a linear or branched alkyl, aryl or aralkyl chain with 1 to 20 carbon atoms or an ether group with 4 to 20 carbon atoms; R_{2E} is a hydrogen atom or a linear or branched alkyl chain with 1 to 4 carbon atoms; and R_{3E} is a linear or branched alkyl, aryl or aralkyl chain with 1 to 20 carbon atoms or an ether group with 4 to 20 carbon atoms.
